(19) United States
(12) Patent Application Publication
(10) Pub. No.: US 2026/0316273 A1
(43) Pub. Date: Oct. 15, 2026

(54) METHOD FOR CONTROLLING MOTION OF ROBOTIC ARM, ROBOTIC ARM AND COMPUTER-READABLE STORAGE MEDIUM

(71) Applicant: UBTECH ROBOTICS CORP LTD, Shenzhen (CN)

(72) Inventors: Xuan LUO, Shenzhen (CN); Chunyu CHEN, Shenzhen (CN); Huan TAN, Shenzhen (CN); Youjun XIONG, Shenzhen (CN)

(21) Appl. No.: 19/686,638

(22) Filed: May 23, 2026

Related U.S. Application Data
(63) Continuation of application No. PCT/CN2023/142217, filed on Dec. 27, 2023.

(30) Foreign Application Priority Data
Nov. 28, 2023 (CN) 202311624625.0

(51) Int. Cl. B25J 9/16; B65G 1/04

(52) U.S. Cl. CPC B25J 9/1666; B65G 1/04

(57) ABSTRACT

A method for controlling motion of a robotic arm includes: decomposing a robotic arm grasping task for a shelf scenario into multiple sub-tasks; determining, based on a geometric dynamical system, a Riemannian motion policy for each of the sub-tasks; and integrating the Riemannian motion policies of the sub-tasks based on a graph computation process of the Riemannian motion policies to obtain a global motion policy of the robotic arm.

### CROSS REFERENCE TO RELATED APPLICATIONS

The present application is a continuation-application of International Application PCT/CN2023/142217 with an international filing date of Dec. 27, 2023, which claims foreign priority to Chinese Patent Application No. 202311624625.0, filed on Nov. 28, 2023, in the China National Intellectual Property Administration, the contents of all of which are hereby incorporated by reference in its entirety.

### TECHNICAL FIELD

The present disclosure generally relates to robotic arms, and in particular, relates to a method for controlling motion of a robotic arm, robotic arm and computer-readable storage medium.

### BACKGROUND

Grasping operations in a shelf environment represent a typical application scenario for service robots and have significant application value in industrial contexts. At present, mainstream solutions in the industry typically involve designing dedicated shelf robots that operate according to predefined motion patterns to grasp objects of specified categories. This is because current mature motion planning techniques, including sampling-based methods, optimization-based methods, and stochastic process-based methods, are still essentially offline planning approaches under existing computational capabilities. As a result, when a general-purpose robotic arm employs the above techniques to perform shelf grasping tasks, the robotic arm must stop its motion each time a grasping operation is updated until a new motion trajectory is computed. For frequent shelf grasping tasks, this significantly reduces execution efficiency.

Although the artificial potential field method, as a mature online planning approach, can mitigate the above issue by performing real-time computation of attractive motions toward a grasping target and repulsive motions away from obstacles, the generation of such motions relies solely on relative positional information between the robotic arm and the target or obstacles. Consequently, the resulting motion policy lacks dexterity, which may cause the robotic arm to exceed motion limits or become trapped in local optima, particularly in complex shelf environments.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic diagram of a scenario where a robotic arm performs a grasping task in a shelf environment.

FIG. 2 illustrates a schematic diagram of an implementation process of RMPflow.

FIG. 3 is a schematic block diagram of a robotic arm according to one embodiment.

FIG. 4 is an exemplary flowchart of a method for controlling motion of a robotic arm according to another embodiment.

FIG. 5 illustrates a schematic block diagram of a robotic arm motion controlling apparatus according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

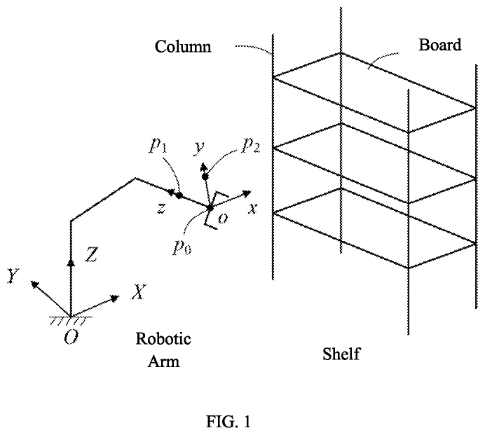

The embodiments of the present disclosure are primarily directed to scenarios in which a robotic arm performs grasping tasks in a shelf environment. FIG. 1 illustrates a schematic diagram of such a scenario. The robotic arm has at least six degrees of freedom and is capable of performing six-dimensional pose grasping. A global coordinate system {0-XYZ} of the scene is located at the base of the robotic arm, and a local coordinate system {o-xyz} of the end effector (e.g., a gripper) is located at the end of the robotic arm. The Z axis and the z axis respectively coincide with the axis of a first joint and the axis of a last joint of the robotic arm. The main structure of the shelf is constructed from cuboids. As shown in FIG. 1, the shelf includes three layers of boards and four vertical columns, forming a total of seven cuboids, each of which can be regarded as an obstacle.

In the embodiments of the present disclosure, based on Riemannian motion policies (RMP), a robotic arm grasping task in a shelf environment is decomposed into a number of sub-tasks defined in different local spaces. Motion policies based on a geometric dynamical system (GDS) model are respectively designed for these sub-tasks. The local motion policies are then integrated into a global motion policy in the joint space according to a structured graph computation process (RMPflow) of Riemannian motion policies. Through this approach, the robotic arm is enabled to perform grasp-reaching motions while simultaneously performing dynamic obstacle avoidance with respect to the recognized environment.

RMP refers to a class of geometric motion policies defined on a Riemannian manifold, which are described by second-order differential equations and embed geometric information. Its mathematical canonical form is given as (α, M)^{M}, where M denotes a m-dimensional Riemannian manifold whose spatial coordinates belong to R^{mμ}; α: P^{m}×P^{m}→P^{m} represents a second-order continuous motion policy, and M: P^{m}×P^{m}→P^{m×m} represents a differential mapping. According to the naming convention in robotic dynamics, α can also be regarded as the desired acceleration, while M can be regarded as an inertia matrix.

In addition to the canonical form, RMP also has a mathematical natural form, given as [f,M]^{M}. In this formulation, f=Mα represents a desired force mapping.

This form of mathematical representation is more convenient for performing RMP-related algebraic operations (RMP-algebra).

RMPflow is a graph computation framework designed for manifold spaces.

Its function is to rapidly integrate local RMPs designed for specific tasks on manifolds of different dimensions into a global RMP in the target space, thereby producing a motion policy that can accomplish all specified tasks. The RMPflow framework primarily relies on three iterative information-flow processing operations: pushforward, pullback, and resolve. Specifically, pushforward refers to the forward propagation of state information flow, pullback refers to the backward propagation of RMP information flow, and resolve refers to the mapping operation that transforms RMP information flow from its natural form back to its canonical form.

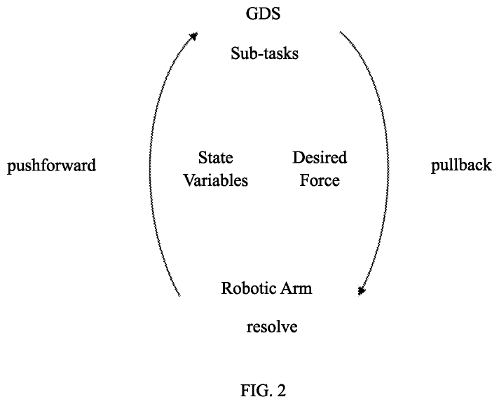

FIG. 2 illustrates a schematic diagram of an implementation process of RMPflow. As shown in the figure, first, a pushforward operation is performed to obtain state information of each sub-task based on the state information of the robotic arm. Next, based on the designed GDS, the natural form of the RMP corresponding to each sub-task is obtained from the state information of each sub-task. Then, a pullback operation is performed to obtain the natural form of the global RMP based on the natural forms of the RMPs of the respective sub-tasks. Finally, a resolve operation is performed to obtain the canonical form of the global RMP based on its natural form.

A geometric dynamical system (GDS) can be regarded as a virtual mechanical system defined on a manifold space, whose system inertia is jointly determined by the configuration and velocity of the mechanical body. A GDS can be represented by a mathematical tuple consisting of four elements, denoted as (M, G, B, φ), and satisfies the following differential equation: (G(x,\dot{x})+Ξ_{G}(x,\dot{x}))\ddot{x}+ξ_{G}(x,\dot{x})=−∇ₓφ(x)−B(x,\dot{x})\dot{x}, where G(x,\dot{x}) is a geometric metric matrix, which can be designed based on the desired response of the mechanical system according to its state (x,\dot{x}); B(x,\dot{x}) and φ(x) respectively denote a damping matrix and a potential function, which may be designed with reference to corresponding terms in conventional mechanical systems; and Ξ_{G} (x,\dot{x}) and ξ_{G}(x,\dot{x}) are curvature-related terms of the system, which can be derived based on G(x,\dot{x}). That is,

$${Ξ}_{G} ( x , \dot{x} ) = \frac{1}{2} {\sum }_{i = 1}^{m} {\dot{x}}_{i} {\partial }_{\dot{x}} {g}_{i} ( x , \dot{x} ) and {ξ}_{G} ( x , \dot{x} ) = {G}^{x} ( x , \dot{x} ) \dot{x} - \frac{1}{2} {∇}_{x} ( {\dot{x}}^{T} G ( x , \dot{x} ) \dot{x} ) ,$$

where G(x,\dot{x})=[∂ₓgᵢ(x,\dot{x})\dot{x}]ᵢ₌₁^{m}, and gᵢ(x,\dot{x}) denotes the i-th column of matrix G(x,\dot{x}).

When an RMP is designed based on a Geometric Dynamical System (GDS) model, the corresponding [f,M]^{M} can be obtained according to the following equations: M(x,\dot{x})=G (x,\dot{x})+Ξ_{G}(x,\dot{x}) and f(x,\dot{x})=M(x,\dot{x})\dot{x}=−∇ₓφ(x)−B(x,\dot{x})\dot{x}−ξ_{G}(x,\dot{x}).

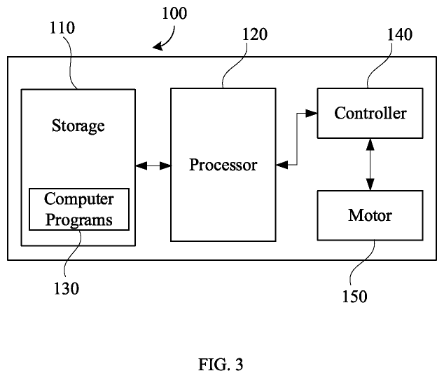

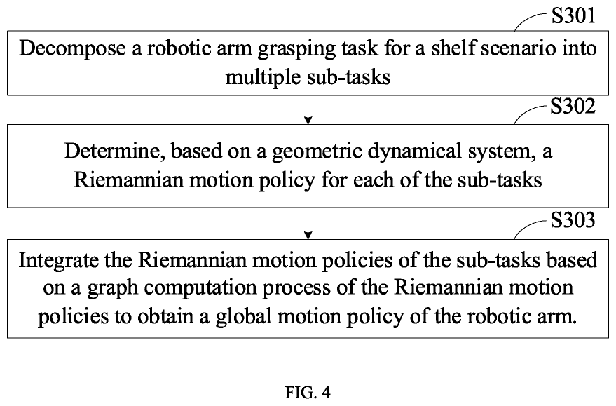

Referring to FIG. 3, in one embodiment, a robotic arm 100 may include a storage 110 and a processor 120. The storage 110 and the processor 120 are directly or indirectly electrically connected to one another to enable data transmission or interaction. For example, they can be electrically connected to each another through one or more communication buses or signal lines. The processor 120 performs corresponding operations by executing the executable computer programs 130 stored in the storage 110. When the processor 120 executes the computer programs 130, the steps in the embodiments of a method for controlling motion of a robotic arm, such as steps S301 to S303 in FIG. 4 are implemented.

The processor 120 may be an integrated circuit chip with signal processing capability. The processor 120 may be a central processing unit (CPU), a graphics processing unit (GPU), a general-purpose processor, a network processor (NP), a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 120 can implement or execute the methods, steps, and logical blocks disclosed in the embodiments of the present disclosure.

The storage 110 may be, but not limited to, a random-access memory (RAM), a read only memory (ROM), a programmable read only memory (PROM), an erasable programmable read-only memory (EPROM), and an electrical erasable programmable read-only memory (EEPROM). The storage 110 may be an internal storage unit of the robotic arm 100, such as a hard disk or a memory. The storage 110 may be an external storage device of the robotic arm 100, such as a plug-in hard disk, a smart memory card (SMC), and a secure digital (SD) card, or any suitable flash cards. Furthermore, the storage 110 may include both an internal storage unit and an external storage device. The storage 110 is to store computer programs, other programs, and data required by the robotic arm 100. The storage 110 can be used to temporarily store data that has been output or is about to be output. Upon receiving an execution instruction, the processor 120 can correspondingly execute the computer program stored on the storage 110.

Exemplarily, the one or more computer programs 130 may be divided into one or more modules/units, and the one or more modules/units are stored in the storage 110 and executable by the processor 120. The one or more modules/units may be a series of computer program instruction segments capable of performing specific functions, and the instruction segments are used to describe the execution process of the one or more computer programs 130 in the robotic arm 100.

It should be noted that the block diagram shown in FIG. 3 is only an example of the robotic arm 100. The robotic arm 100 may include more or fewer components than what is shown in FIG. 3, or have a different configuration than what is shown in FIG. 3. For example, the processor 120 may be electrically connected to a controller 140, and the controller 140 may be electrically connected to a motor 150.

The controller 140 may receive instructions from the processor 120 and operate the motor 150 to change the robotic arm 100. Each component shown in FIG. 3 may be implemented in hardware, software, or a combination thereof.

FIG. 4 is an exemplary flowchart of a method for controlling motion of a robotic arm according to one embodiment. This method can be implemented by the robotic arm 100 described above. In one embodiment, the method may include steps S301 to S304.

Step S301: Decompose a robotic arm grasping task for a shelf scenario into multiple sub-tasks.

In one embodiment, the robotic arm grasping task for a shelf scenario can be decomposed into a pose-reaching sub-task, a shelf obstacle avoidance sub-task, and a joint limit avoidance sub-task.

Step S302: Determine, based on a geometric dynamical system, a Riemannian motion policy for each of the sub-tasks.

In one embodiment, a pose-reaching sub-task RMP, a shelf obstacle avoidance sub-task RMP, and a joint limit avoidance sub-task RMP may be determined, respectively.

For the pose-reaching sub-task RMP, three non-collinear control points may be defined at the end effector of the robotic arm, and a position-reaching RMP of the three control points is determined as the pose-reaching sub-task RMP.

As shown in FIG. 1, three non-collinear control points may be defined at the end effector (i.e., the gripper) of the robotic arm. One control point p₀ coincides with the origin of the gripper coordinate system, one control point p₁ is located on the Z-axis, and another control point p₂ is located on the Y-axis. When only the control point p₀ is controlled to move to a designated position, a gripper position-reaching task of the robotic arm grasping operation can be achieved. When the control points p₀ and p₁ are controlled, the gripper pose is constrained such that it can only rotate about the axis of the last joint of the robotic arm. When all three control points are controlled simultaneously, the gripper pose is fully constrained, thereby achieving a pose-reaching task for robotic grasping. Accordingly, a pose-reaching RMP can be replaced by multiple position-reaching RMPs of control points, without the need to separately tune a set of parameters for a dedicated pose-reaching RMP.

Taking control point p₀ among the three control points as an example, in the pushforward design of its position-reaching RMP, the state variables in the joint space of the robotic arm are denoted as (q, \dot{q}), and the state variables of p₀ in the operational space are denoted as (x₀, \dot{x}₀). Then, the following relationships hold: x₀=Ψ₀(q) and

$${\dot{x}}_{0} = {J}_{0}^{g} ( q ) \dot{q} ,$$

where Ψ₀ denotes the forward kinematics of the robotic arm corresponding to control point p₀, and

$${J}_{0}^{g} = {\partial }_{q} {ψ}_{0}$$

denotes the Jacobian matrix of the position-reaching RMP.

In the GDS design, the manifold space to which the control point p₀ belongs may be denoted as Ξ₀, and the natural form of the corresponding position-reaching RMP is denoted as

$${[ {f}_{0}^{g} , {M}_{0}^{g} ]}^{{Ξ}_{0}} .$$

Let (Ξ₀, G_{g}, B_{g}, φ_{g}) denote the GDS designed for this RMP. Then, the following relationships hold: G_{g}=wI, w=r_{σ}(wᵤ−wₗ)+wₗ, r_{σ}=exp(−∥e∥²/(2σ²)),

$${B}_{g} = {r}_{d} w , {∇}_{e} {Φ}_{g} = {r}_{p} {r}_{α} w \hat{e} , and {r}_{α} = \frac{1 - exp ( - 2 a ‖ e ‖ )}{1 + exp ( - 2 a ‖ e ‖ )} ,$$

where I denotes an identity matrix having the same dimensionality as the joint space of the robotic arm; w denotes a metric coefficient, with wᵤ and wₗ respectively representing its upper and lower bounds; rₚ and r_{d} respectively denote a proportional gain and a velocity gain;

$$e = {x}_{0} - {x}_{0}^{g}$$

denotes the vector difference between the current state and the target position; and ê=e/∥e∥ denotes the unit vector of e. Therefore, the following equations can be obtained:

$${M}_{0}^{g} = {G}_{g} , {ξ}_{{G}_{g}} = \frac{1}{2} ( {‖ \dot{e} ‖}^{2} {∇}_{e} w - 2 \dot{e} {\dot{e}}^{T} {∇}_{e} w ) {f}_{0}^{g} = - {∇}_{e} {Φ}_{g} - {B}_{g} \dot{e} - {ξ}_{{G}_{g}} .$$

The cases for control points p₁ and p₂ are similar to that of p₀, and the pushforward and GDS design of their position-reaching RMPs may refer to the above description for p₀. Details are not repeated herein for brevity.

For the shelf obstacle avoidance sub-task RMP, shape features of the shelf may be obtained, and the shelf obstacle avoidance sub-task RMP is determined based on the shape features of the shelf. The shape features of the shelf may include size vectors, position vectors, and rotation matrices of the cuboid obstacles constituting the shelf.

Considering that the shelf structure is composed of nₒ cuboid obstacles, control point p₀ and the i-th cuboid obstacle are taken as an example. In the pushforward design of the obstacle avoidance RMP, the size vector lᵢ, position vector tᵢ, and rotation matrix Rᵢ of the i-th cuboid obstacle are assumed to be known. Specifically, lᵢ consists of the length, width, and height of the cuboid, and tᵢ represents the coordinates of the cuboid center in the global coordinate system. A local coordinate system of the obstacle is established at the center of the cuboid, with its three axes extending along the lengthwise, widthwise, and heightwise directions, respectively. Rᵢ denotes the rotation matrix of the local coordinate system relative to the global coordinate system. Let s_{0,i} denote the shortest distance between control point p₀ and the i-th cuboid, and θᵢ denote the shortest-distance function. Then, the following relationships hold: s_{0,i}=θᵢ(x₀)=(Ψ₀·θᵢ)(q) and

$${\dot{s}}_{0 , i} = {J}_{0 , i}^{a} \dot{q} ,$$

where

$${J}_{0 , i}^{a} = {\partial }_{q} ( {ψ}_{0} ∘ {θ}_{i} ) = [ {\partial }_{{x}_{o}} {θ}_{i} ] {J}_{0}^{g}$$

denotes the Jacobian matrix of the cuboid obstacle avoidance RMP. According to the derivation of the shortest-distance function for a cuboid, it can be obtained that:

$${c}_{0 , i} = {R}_{i}^{T} ( {x}_{0} - {t}_{i} ) , {r}_{0 , i} = [ diag ( sgn ( {c}_{0 , i} ) ) ] {c}_{0 , i} - \frac{1}{2} {l}_{i} , {d}_{0 , i} = [ diag ( max ( sgn ( {r}_{0 , i} ) , 0 ) ) ] {r}_{0 , i} , {s}_{0 , i} = ‖ {d}_{0 , i} ‖ , and {\dot{s}}_{0 , i} = \frac{{d}_{0 , i}^{T}}{{s}_{0 , i}} [ diag ( max ( sgn ( {r}_{0 , i} ) , 0 ) ) ] [ diag ( sgn ( {c}_{0 , i} ) ) ] {R}_{i}^{T} {\dot{x}}_{0} ,$$

where sgn(v) denotes an element-wise sign operation on the vector v, max(v, 0) denotes an element-wise maximum operation between the vector v and 0, and diag(v) denotes a transformation that converts the vector v into a diagonal matrix with the same dimensionality, whose diagonal elements correspond to the elements of the vector v.

In the GDS design, the shortest-distance manifold space corresponding to the i-th cuboid may be denoted as Σᵢ, and the natural form of the corresponding obstacle avoidance RMP is denoted as

$${[ {f}_{0 , i}^{a} , {m}_{0 , i}^{a} ]}^{{\sum }_{i}} .$$

Let (Σᵢ, gₐ, bₐ, φₐ) denote the GDS designed for this RMP. Then, the following relationships hold:

$${g}_{a} = w ( {s}_{0 , i} ) u ( {\dot{s}}_{0 , i} ) , w ( {s}_{0 , i} ) = \frac{max ( {s}_{u} - {s}_{0 , i} , 0 )}{max ( {s}_{0 , i} - {s}_{l} , ε )} , u ( {\dot{s}}_{0 , i} ) = \{ \begin{matrix}1 - exp ( - {\dot{s}}_{0 , i} / ( 2 {σ}^{2} ) ) & {\dot{s}}_{0 , i} < 0 \\ 0 & {\dot{s}}_{0 , i} \geq 0\end{matrix} , {b}_{a} = {r}_{d} {g}_{a} ,$$

and ∇ₛ_{_{o,i}}φₐ=rₚw∇ₛ_{_{o,i}}w, where sᵤ and sₗ respectively denote a triggering distance and a minimum safety distance for the obstacle avoidance task, ε denotes a small positive value, and rₚ and r_{d} respectively denote a proportional gain and a velocity gain. Accordingly, the following equations can be obtained:

$${m}_{0 , i}^{a} = {g}_{a} + \frac{1}{2} {\dot{s}}_{0 , i} w {∇}_{{\dot{s}}_{0 , i}} u , {ξ}_{{g}_{a}} = \frac{1}{2} {\dot{s}}_{0 , i} u {∇}_{{s}_{0 , i}} w , and {f}_{0 , i}^{a} = - {∇}_{{s}_{0 , i}} {φ}_{a} - {b}_{a} {\dot{s}}_{0 , i} - {ξ}_{{g}_{a}} .$$

For any control point and any cuboid obstacle, the pushforward and GDS design of the corresponding obstacle avoidance RMP may refer to the above description for the obstacle avoidance RMP between control point p₀ and the i-th cuboid obstacle. Details are not repeated herein for brevity.

For the joint limit avoidance sub-task RMP, the finite configuration space of the robotic arm may be mapped to an unbounded real space to determine the joint limit avoidance RMP. In this process, the state variables of the robotic arm may first be mapped to an unbounded real space P^{mμ} for dynamic system design, and then the resulting motion policy may be mapped back to the finite-dimensional configuration space ^{μ}m for motion computation. Two implementation approaches may be adopted. The first approach involves first mapping state variables through computation and then designing a motion policy based on the GDS model. The second approach, conversely, incorporates the mapping of state variables directly into the design of the GDS.

Taking the second approach as an example, in which the mapping of the state variables is directly reflected in the GDS design, no mapping of state information is required during the pushforward design of the joint limit avoidance RMP. That is, the state parameters of the robotic arm, denoted as (q, \dot{q}), are directly used in the joint limit avoidance RMP. Accordingly, the corresponding Jacobian matrix J^{l}=Iₘ is an identity matrix of dimension ^{μ}m.

In the GDS design, let

$$q = {[ {q}_{i} ]}_{i = 1}^{m} ,$$

the configuration space of the robotic arm be denoted as X, and the natural form of the joint limit avoidance RMP be denoted as [f^{l},M^{l}]^{X}. Let (X, Gₗ, Bₗ, φₗ) denote the GDS designed for this RMP. Then, the following relationships hold:

$${G}_{l} = diag ( {[ {g}_{i} ]}_{i = 1}^{m} ) , {g}_{i} = {d}_{i}^{- 2} {d}_{i} = {s}_{i} ( {α}_{u , i} {u}_{i} + ( 1 - {α}_{u , i} ) ) + ( 1 - {s}_{i} ) ( {α}_{l , i} {u}_{i} + ( 1 - {α}_{l , i} ) ) , {s}_{i} = \frac{{q}_{i} - {q}_{l , i}}{{q}_{u , i} - {q}_{l , i}} , {u}_{i} = 4 {s}_{i} ( 1 - {s}_{i} ) , {α}_{u , i} = 1 - exp ( - \frac{{( max ( {\dot{q}}_{i} , 0 ) )}^{2}}{2 {σ}^{2}} ) , {α}_{l , i} = 1 - exp ( - \frac{{( min ( {\dot{q}}_{i} , 0 ) )}^{2}}{2 {σ}^{2}} ) , {B}_{l} = diag ( {[ {b}_{i} ]}_{i = 1}^{m} ) , {b}_{i} = {r}_{d} {d}_{i} , {∇}_{q} {Φ}_{l} = {[ {∇}_{{q}_{i}} {Φ}_{l} ]}_{i = 1}^{m} , and {∇}_{{q}_{i}} {Φ}_{l} = {r}_{p} {d}_{i} ( {q}_{i} - {q}_{0 , i} ) ,$$

where q_{u,i}, q_{l,i}, and q_{0,i} respectively denote the upper limit, lower limit, and midpoint of the joint position, and rₚ and r_{d} respectively denote a proportional gain and a velocity gain. Accordingly, the following equations can be obtained:

$${M}^{l} = {G}_{l} , {ξ}_{{G}_{l}} = {[ {ξ}_{{g}_{i}} ]}_{i = 1}^{m} , {ξ}_{{g}_{i}} = \frac{1}{2} {\dot{q}}_{i}^{2} {∇}_{{q}_{i}} {g}_{i} = - \frac{1}{{d}_{i}^{3}} {∇}_{{q}_{i}} {d}_{i} , {∇}_{{q}_{i}} {d}_{i} = ( {α}_{u , i} {u}_{i} + ( 1 - {α}_{u , i} ) ) {∇}_{{q}_{i}} {s}_{i} + {s}_{i} {α}_{u , i} {∇}_{{q}_{i}} {u}_{i} - ( {α}_{l , i} {u}_{i} + ( 1 - {α}_{l , i} ) ) {∇}_{{q}_{i}} {s}_{i} + ( 1 - {s}_{i} ) {α}_{l , i} {∇}_{{q}_{i}} {u}_{i} , {∇}_{{q}_{i}} {s}_{i} = \frac{1}{{q}_{u , i} - {q}_{l , i}} , {∇}_{{q}_{i}} {u}_{i} = 4 ( 1 - {s}_{i} ) {∇}_{{q}_{i}} {s}_{i} - 4 {s}_{i} {∇}_{{q}_{i}} {s}_{i} , and {f}^{l} = - {∇}_{q} {Φ}_{l} - {B}_{i} \dot{q} - {ξ}_{{G}_{l}} .$$

Through the above process, the pose-reaching sub-task RMP, the shelf obstacle avoidance sub-task RMP, and the joint limit avoidance sub-task RMP are respectively determined.

Step S303: Integrate the Riemannian motion policies of the sub-tasks based on a graph computation process of the Riemannian motion policies to obtain a global motion policy of the robotic arm.

The robotic arm grasping task in the shelf environment employs at least N=nₗ+n_{g}+nₚ×nₒ sub-task RMPs. Among them, there are nₗ=1 joint limit avoidance RMP and n_{g}=3 position-reaching RMPs. Given nₚ collision-checking control points on the robotic arm and nₒ cuboid obstacles, the number of obstacle avoidance RMPs is nₚ×nₒ.

In the embodiments of the present disclosure, the natural form of the global motion policy may be determined based on the natural forms of the RMPs of the respective sub-tasks, and the canonical form of the global motion policy may be determined based on the natural form of the global motion policy.

After determining each sub-task RMP, the natural form [f, M]^{X} of the global motion policy can be obtained based on the pullback operation according to the natural forms of the respective sub-task RMPs:

$$f = {\sum }_{i = 1}^{N} {J}_{i}^{T} ( {f}_{i} - {M}_{i} {\dot{J}}_{i} \dot{q} ) and M = {\sum }_{i = 1}^{N} {J}_{i}^{T} {M}_{i} {J}_{i} ,$$

where

$${\{ {f}_{i} \}}_{i = 1}^{N} , {\{ {M}_{i} \}}_{i = 1}^{N} , and {\{ {U}_{i} \}}_{i = 1}^{N}$$

respectively represent the sequences formed by the combined rearrangement of the desired forces, inertia matrices, and Jacobian matrices of all sub-task RMPs.

By performing the resolve operation, the global motion policy is mapped from the natural form back to the canonical form, thereby obtaining the joint acceleration control variable of the global motion policy: α=M⁺f, where M⁺(M^{T}M)⁻¹M^{T}, which denotes the pseudoinverse of M.

After obtaining the joint acceleration control variable, motion control of the robotic arm may be performed according to the control variable, such that the robotic arm is enabled to complete a task of grasping an object from the shelf.

By executing the aforementioned methods-leveraging both the high efficiency of the graph-based computation pipeline within the Riemannian motion policy and the richness and robustness of the geometric dynamical system model-real-time and stable motion generation for robotic arms is achieved. Even within relatively complex shelving environments, this approach effectively guarantees the efficiency and safety of robotic arm grasping tasks.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

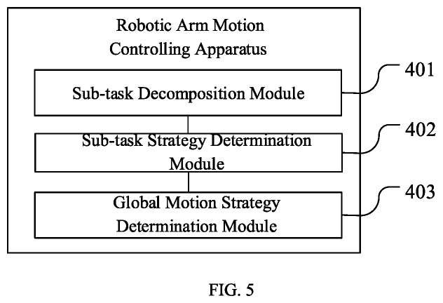

Corresponding to the method described in the foregoing embodiments, FIG. 5 illustrates a schematic block diagram of a robotic arm motion controlling apparatus according to one embodiment. The robotic arm motion controlling apparatus may include a sub-task decomposition module 401, a sub-task strategy determination module 402 and global motion policy determination module 403. The sub-task decomposition module 401 is to decompose a robotic arm grasping task for a shelf scenario into a plurality of sub-tasks. The sub-task strategy determination module 402 is to determine, based on a geometric dynamical system, a Riemannian motion policy for each of the sub-tasks. The global motion policy determination module 403 is to integrate the Riemannian motion policies of the sub-tasks based on a graph computation process of the Riemannian motion policies to obtain a global motion policy of the robotic arm.

In one embodiment, the sub-task decomposition module 401 is to decompose the robotic arm grasping task for the shelf scenario into a pose-reaching sub-task, a shelf obstacle avoidance sub-task, and a joint limit avoidance sub-task.

In one embodiment, the sub-task strategy determination module 402 may include a pose-reaching sub-task strategy determination unit, a shelf obstacle avoidance sub-task strategy determination unit and a joint limit avoidance sub-task strategy determination unit. The pose-reaching sub-task strategy determination unit is to determine a Riemannian motion policy for the pose-reaching sub-task. The shelf obstacle avoidance sub-task strategy determination unit is to determine a Riemannian motion policy for the shelf obstacle avoidance sub-task. The joint limit avoidance sub-task strategy determination unit is to determine a Riemannian motion policy for the joint limit avoidance sub-task.

In one embodiment, the pose-reaching sub-task strategy determination unit is further to determine three non-collinear control points at an end effector of the robotic arm, and determine a position-reaching Riemannian motion policy for the three control points as the Riemannian motion policy for the pose-reaching sub-task.

In one embodiment, the shelf obstacle avoidance sub-task strategy determination unit is further to obtain shape features of a shelf and determine the Riemannian motion policy for the shelf obstacle avoidance sub-task based on the shape features of the shelf.

In one embodiment, the shape features of the shelf include size vectors, position vectors, and rotation matrices of a plurality of cuboid obstacles forming the shelf.

In one embodiment, the joint limit avoidance sub-task strategy determination unit is to map a finite configuration space of the robotic arm to an unbounded real space to determine the Riemannian motion policy for the joint limit avoidance sub-task.

In one embodiment, the global motion policy determination module 403 is further to determine a natural form of the global motion policy based on natural forms of the Riemannian motion policies of the sub-tasks; and determine a canonical form of the global motion policy based on the natural form of the global motion policy.

Those skilled in the art will readily understand that, for the sake of convenience and conciseness in description, the specific working processes of the above-described device, modules, and units may refer to the corresponding processes in the foregoing method embodiments, and are not repeated herein.

In the above embodiments, the descriptions of each embodiment focus on different aspects. Any features not specifically described or disclosed in one embodiment may be referred to in the relevant descriptions of other embodiments.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In one embodiment, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. In addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for controlling motion of a robotic arm, comprising:
decomposing a robotic arm grasping task for a shelf scenario into a plurality of sub-tasks;
determining, based on a geometric dynamical system, a Riemannian motion policy for each of the sub-tasks; and
integrating the Riemannian motion policies of the sub-tasks based on a graph computation process of the Riemannian motion policies to obtain a global motion policy of the robotic arm.

2. The method of claim 1, wherein decomposing the robotic arm grasping task for the shelf scenario into the plurality of sub-tasks comprises:
decomposing the robotic arm grasping task for the shelf scenario into a pose-reaching sub-task, a shelf obstacle avoidance sub-task, and a joint limit avoidance sub-task;
wherein determining the Riemannian motion policy for each of the sub-tasks comprises:
determining a Riemannian motion policy for the pose-reaching sub-task, determining a Riemannian motion policy for the shelf obstacle avoidance sub-task, and determining a Riemannian motion policy for the joint limit avoidance sub-task.

3. The method of claim 2, wherein determining the Riemannian motion policy for the pose-reaching sub-task comprises:
determining three non-collinear control points at an end effector of the robotic arm; and
determining a position-reaching Riemannian motion policy for the three control points as the Riemannian motion policy for the pose-reaching sub-task.

4. The method of claim 2, wherein determining the Riemannian motion policy for the shelf obstacle avoidance sub-task comprises:
obtaining shape features of a shelf; and
determining the Riemannian motion policy for the shelf obstacle avoidance sub-task based on the shape features of the shelf.

5. The method of claim 4, wherein the shape features of the shelf comprise size vectors, position vectors, and rotation matrices of a plurality of cuboid obstacles forming the shelf.

6. The method of claim 2, wherein determining the Riemannian motion policy for the joint limit avoidance sub-task comprises:
mapping a finite configuration space of the robotic arm to an unbounded real space to determine the Riemannian motion policy for the joint limit avoidance sub-task.

7. The method of claim 1, wherein integrating the Riemannian motion policies of the sub-tasks based on the graph computation process to obtain the global motion policy of the robotic arm comprises:
determining a natural form of the global motion policy based on natural forms of the Riemannian motion policies of the sub-tasks; and
determining a canonical form of the global motion policy based on the natural form of the global motion policy.

8. A robotic arm comprising:
one or more processors; and
a memory coupled to the one or more processors, the memory storing programs that, when executed by the one or more processors, cause performance of operations comprising:
decomposing a robotic arm grasping task for a shelf scenario into a plurality of sub-tasks;
determining, based on a geometric dynamical system, a Riemannian motion policy for each of the sub-tasks; and
integrating the Riemannian motion policies of the sub-tasks based on a graph computation process of the Riemannian motion policies to obtain a global motion policy of the robotic arm.

9. The robotic arm of claim 8, wherein decomposing the robotic arm grasping task for the shelf scenario into multiple sub-tasks comprises:
decomposing the robotic arm grasping task for the shelf scenario into a pose-reaching sub-task, a shelf obstacle avoidance sub-task, and a joint limit avoidance sub-task;
wherein determining the Riemannian motion policy for each of the sub-tasks comprises:
determining a Riemannian motion policy for the pose-reaching sub-task, determining a Riemannian motion policy for the shelf obstacle avoidance sub-task, and determining a Riemannian motion policy for the joint limit avoidance sub-task.

10. The robotic arm of claim 9, wherein determining the Riemannian motion policy for the pose-reaching sub-task comprises:
determining three non-collinear control points at an end effector of the robotic arm; and
determining a position-reaching Riemannian motion policy for the three control points as the Riemannian motion policy for the pose-reaching sub-task.

11. The robotic arm of claim 9, wherein determining the Riemannian motion policy for the shelf obstacle avoidance sub-task comprises:
obtaining shape features of a shelf, and
determining the Riemannian motion policy for the shelf obstacle avoidance sub-task based on the shape features of the shelf.

12. The robotic arm of claim 11, wherein the shape features of the shelf comprise size vectors, position vectors, and rotation matrices of a plurality of cuboid obstacles forming the shelf.

13. The robotic arm of claim 9, wherein determining the Riemannian motion policy for the joint limit avoidance sub-task comprises:
mapping a finite configuration space of the robotic arm to an unbounded real space to determine the Riemannian motion policy for the joint limit avoidance sub-task.

14. The robotic arm of claim 8, wherein integrating the Riemannian motion policies of the sub-tasks based on the graph computation process to obtain the global motion policy of the robotic arm comprises:
determining a natural form of the global motion policy based on natural forms of the Riemannian motion policies of the sub-tasks; and
determining a canonical form of the global motion policy based on the natural form of the global motion policy.

15. A non-transitory computer-readable storage medium storing instructions that, when executed by at least one processor of a robotic arm, cause the at least one processor to perform a method for controlling motion of the robotic arm, the method comprising:
decomposing a robotic arm grasping task for a shelf scenario into a plurality of sub-tasks;
determining, based on a geometric dynamical system, a Riemannian motion policy for each of the sub-tasks; and
integrating the Riemannian motion policies of the sub-tasks based on a graph computation process of the Riemannian motion policies to obtain a global motion policy of the robotic arm.

16. The non-transitory computer-readable storage medium of claim 15, wherein decomposing the robotic arm grasping task for the shelf scenario into multiple sub-tasks comprises:
decomposing the robotic arm grasping task for the shelf scenario into a pose-reaching sub-task, a shelf obstacle avoidance sub-task, and a joint limit avoidance sub-task;
wherein determining the Riemannian motion policy for each of the sub-tasks comprises:
determining a Riemannian motion policy for the pose-reaching sub-task, determining a Riemannian motion policy for the shelf obstacle avoidance sub-task, and determining a Riemannian motion policy for the joint limit avoidance sub-task.

17. The non-transitory computer-readable storage medium of claim 16, wherein determining the Riemannian motion policy for the pose-reaching sub-task comprises:
determining three non-collinear control points at an end effector of the robotic arm; and
determining a position-reaching Riemannian motion policy for the three control points as the Riemannian motion policy for the pose-reaching sub-task.

18. The non-transitory computer-readable storage medium of claim 16, wherein determining the Riemannian motion policy for the shelf obstacle avoidance sub-task comprises:
obtaining shape features of a shelf; and
determining the Riemannian motion policy for the shelf obstacle avoidance sub-task based on the shape features of the shelf.

19. The non-transitory computer-readable storage medium of claim 18, wherein the shape features of the shelf comprise size vectors, position vectors, and rotation matrices of a plurality of cuboid obstacles forming the shelf.

20. The non-transitory computer-readable storage medium of claim 16, wherein determining the Riemannian motion policy for the joint limit avoidance sub-task comprises:
mapping a finite configuration space of the robotic arm to an unbounded real space to determine the Riemannian motion policy for the joint limit avoidance sub-task.
